(19) United States
(12) Patent Application Publication
(10) Pub. No.: US 2015/0247591 A1
(43) Pub. Date: Sep. 3, 2015

(54) SYSTEM FOR RETAINING MULITPLE HOSES

(71) Applicant: Caterpillar Inc., Peoria, IL (US)

(72) Inventor: Nirmal Goldwin, Chennai (IN)

(73) Assignee: Caterpillar Inc., Peoria, IL (US)

(21) Appl. No.: 14/711,803

(22) Filed: May 14, 2015

(51) Int. Cl. F16L 3/223; F16H 31/00; F16L 3/10

(52) U.S. Cl. CPC F16L 3/2235; F16L 3/1091; F16H 31/002

(57) ABSTRACT

The present disclosure is related to a system for retaining multiple hoses. The system includes multiple spacer members and an inner member having multiple recesses. Each of the hoses is received between the corresponding recess and the corresponding spacer member. The system also includes two brackets that retain the hoses between the recesses and the spacer members. The system further includes a rack and gear mechanism that allows tightening of the hoses in a locked configuration of the system. The system includes a ratchet and pawl mechanism that retains the system in the locked configuration. Further, the ratchet and pawn mechanism may be released to actuate the system to an unlocked configuration and allow loosening of the hoses.

### TECHNICAL FIELD

The present disclosure relates to a system for detachably retaining a multiple hoses.

### BACKGROUND

A machine such as, a hydraulic excavator, generally includes a hydraulic system to actuate various movable components, for example, a boom, an arm, a bucket, an upper body and ground engaging members of the hydraulic system typically includes multiple hoses to transport hydraulic fluid between various hydraulic components, such as cylinders, pumps, valves, hydraulic motors, and the like. The hoses may have different dimensions and are routed between hydraulic components located at different locations on the machine. Typically, individual retaining structures are provided for each of the hoses, thereby increasing time, complexity and cost of assembly. Further, the hoses may not be arranged in an organized manner. This may result in adjacent hoses rubbing against one another. Such rubbing may cause wear and the hoses and reduce their life. Moreover, the hoses may sag due to self weight which may reduce efficiency of fluid transport through the hoses.

For reference, U.S. Patent Publication 2007/0120023 (the '023 publication) discloses a hydraulic hose retention device for a work vehicle. The assembly includes an elastomeric body having slotted apertures that support a plurality of hydraulic hoses and a securing assembly that secures the hydraulic hoses in place. However, during assembly of the hoses with the slotted apertures of the '023 publication, an operator has to flex the slotted apertures apart one at a time and insert a hose into the corresponding flexed slotted apertures. Flexing all the slotted apertures may be a time consuming and labor intensive process.

### SUMMARY OF THE DISCLOSURE

In one aspect of the present disclosure, a system for detachably retaining a plurality of hoses is provided. The system includes an inner member having a first end, a second end distal to the first end and a pair of lateral ends extending between the first end and the second end. The inner member defines a plurality of first recesses at the first end and a plurality of second recesses at the second end. The inner member further defines a first groove proximate the first end, a second groove proximate the second end and a mounting opening disposed between the first groove and the second groove.

The system also includes a first bracket member and a second bracket member. The first bracket member includes a first retaining portion disposed adjacent to the first end of the inner member and a pair of first projecting portions extending from ends of the first retaining portion. Further, each of the pair of first projecting portions is disposed adjacent to a corresponding lateral end of the pair of lateral ends of the inner member. The second bracket member includes a second retaining portion disposed adjacent to the second end of the inner member and a pair of second projecting portions extending from ends of the first retaining portion. Further, each of the pair of second projecting portions is disposed adjacent to the corresponding lateral end of the pair of lateral ends of the inner member. The system further includes a fastening member arranged to detachably couple each of the pair of first projecting portions of the first bracket member to each of the pair of second projecting portions of the second bracket member.

The system also includes a plurality of first spacer members and a plurality of second spacer members. The plurality of first spacer members is disposed between the first retaining portion of the first bracket member and the first end of the inner member. Each of the plurality of first spacer members and a corresponding first recess of the plurality of first recesses of the inner member are structured and arranged to detachably retain a corresponding hose of the plurality of hoses therebetween. The plurality of second spacer members is disposed between the second retaining portion of the second bracket member and the second end of the inner member. Each of the plurality of second spacer members and a corresponding second recess of the plurality of second recesses of the inner member are structured and arranged to detachably retain a corresponding hose of the plurality of hoses therebetween.

The system also includes a gear member which further includes a mounting portion rotatably received in the mounting opening of the inner member and a gear portion disposed adjacent to the mounting portion. The system includes a ratchet wheel coupled to the gear portion of the gear member to rotatably lock the ratchet wheel with respect to the gear member. The ratchet wheel member also defines a locking recess at a top surface thereof. The locking recess of the ratchet wheel is adapted to engage with a tool for rotation of the gear member.

The system further includes a first locking member and a second locking member. The first locking member includes a first base portion slidably received in the first groove of the inner member, a first rack portion extending from the first base portion along a first direction and arranged to engage with the gear portion of the gear member, and a plurality of first protruding portions extending from the first base portion along a second direction opposite to the first direction. The second locking member includes a second base portion slidably received in the second groove of the inner member, a second rack portion extending from the second base portion along the second direction and is arranged to engage with the gear portion of the gear member, and a along the first direction. The system includes a pair of spring members coupled plurality of second protruding portions extending from the second base portion between respective ends of the first base portion of the first locking member and respective ends of the second base portion of the second locking member. Further, each of the pair of spring members is arranged to bias the first base portion along the first direction and the second base portion along the second direction.

Moreover, the system includes a first pusher member and a second pusher member. The first pusher member has a first inner surface arranged to contact the plurality of first protruding portions of the first locking member and a first outer surface opposite to the first inner surface. The first pusher also includes a first cover member disposed on the first outer surface. Further, the first cover member is arranged to selectively press against the plurality of hoses retained at the first end of the inner member. The second pusher member has a second inner surface arranged to contact the plurality of second protruding portions of the second locking member and a second outer surface opposite to the second inner surface. The second pusher member also includes a second cover member disposed on the second outer surface. Further, the second cover member is arranged to selectively press against the plurality of hoses retained at the second end of the inner member.

The system includes an outer member disposed on the inner member. The outer member includes a middle portion, a first lateral portion disposed adjacent to the middle portion and a second lateral portion disposed adjacent to the middle portion. The first lateral portion defines a plurality of first apertures arranged to movably receive the plurality of first protruding portions of the first locking member therethrough. The second lateral portion defines a plurality of second apertures arranged to movably receive the plurality of second protruding portions of the second locking member therethrough.

The system also includes a block member coupled to the middle portion of the outer member. The block member defines a hole aligned with the locking recess of the ratchet wheel and a slot. The hole of the block member is adapted to receive a tool therethrough for engagement with the locking recess of the ratchet wheel.

The system further includes a pawl member rotatably disposed with respect to the block member. The pawl member includes a pawl portion adapted to selectively engage with the ratchet wheel to rotatably lock the gear member about an unlocking direction and allow rotation of the gear member about a locking direction. The pawl member also includes a lever disposed on the pawl portion. The lever extends through the slot of the block member. The system includes a pawl spring adapted to bias the pawl member into engagement with the ratchet wheel.

Further, the gear member is configured to be rotated in the locking direction to move the first locking member along the second direction and the second locking member along the first direction in order to move the first pusher member and the second pusher into pressing engagement with the plurality of hoses. Further, the lever is configured to be moved in the slot of the block member to disengage the pawl portion of the pawl member from the ratchet wheeland allow the gear member to rotate in the unlocking direction in order to remove the first pusher member and the second pusher member from pressing engagement with the plurality of hoses.

Other features and aspects of this disclosure will be apparent from the following description and the accompanying drawings.

### BRIEF DESCRIPTION OF THE DRAWINGS

FIG. 1 is a perspective view of a system having a plurality of hoses retained with the system, according to an embodiment of the present disclosure;

FIG. 2 is a top view of the system of FIG. 1, according to the embodiment of the present disclosure;

FIG. 3 is a disassembled view of the system, according to an embodiment of the present disclosure;

FIG. 4 is a perspective view of the system showing assembling of the hoses;

FIG. 5A is a top view of the system in an unlocked configuration with a outer member removed; and

FIG. 5B is a top view of the system of FIG. 5A in a locked configuration.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

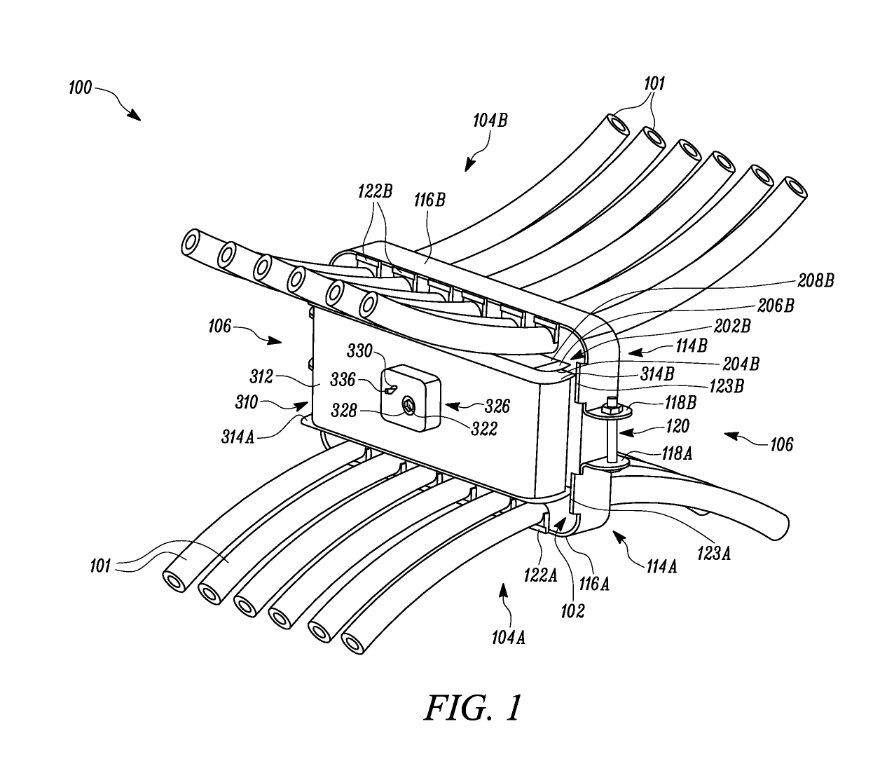

FIG. 1 shows a system 100 for detachably retaining a plurality of hoses 101 (partially shown in FIG. 1), according to an embodiment of the present disclosure. In an example, the hoses 101 may be a part of a machine (not shown). The machine may be, for example, a hydraulic excavator having a hydraulic system configured to actuate various movable components, for example, a boom, an arm, a bucket, an upper body and ground engaging members. In other embodiments, the machine may be a loader, a dozer, an off-highway truck, and the like. The hoses 101 may be adapted to transport hydraulic fluids between various hydraulic components, such as cylinders, pumps, valves, hydraulic motors, and the like. Each of the hoses 101 may be coupled at both ends with a hydraulic component. Further, the hoses 101 may run along different locations on the machine. The hoses 101 may also be of different diameters and lengths, and may carry hydraulic fluids with varying pressures. In an embodiment, each of the hoses 101 may be made of a flexible material that allows deformation of the hoses 101.

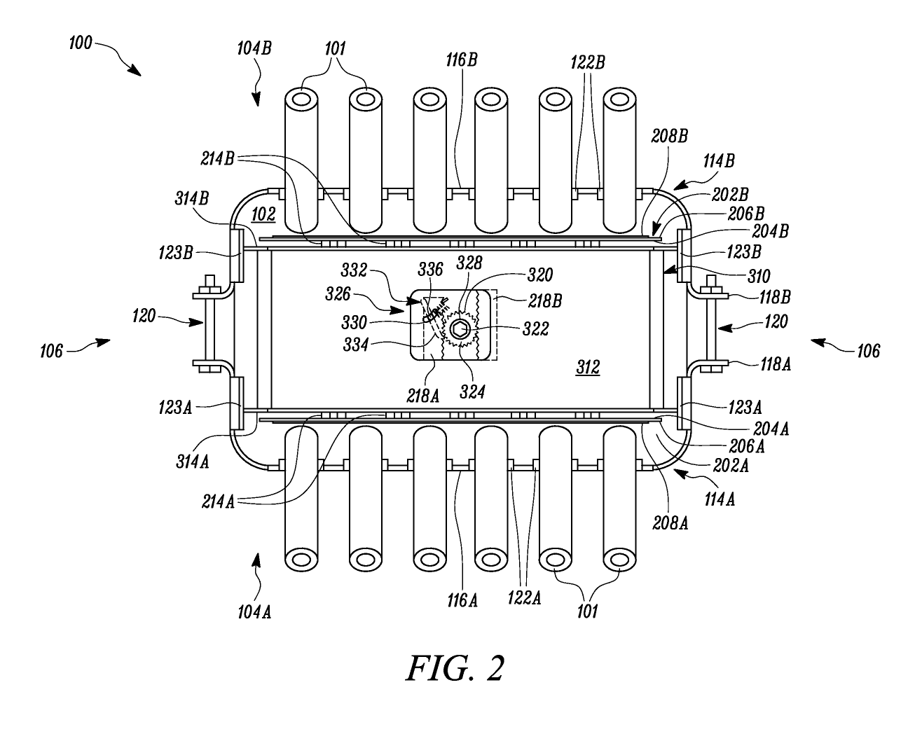

Referring to FIGS. 1 to 3, the system 100 includes an inner member 102 that may be made of various materials like elastomers, plastic, metals, metallic alloys, and the like. The inner member 102 includes a first end 104A, a second end 104B distal to the first end 104A, and a pair of lateral ends 106 extending between the first end 104A and the second end 104B. The inner member 102 also defines a plurality of first recesses 108A at the first end 104A and a plurality of second recesses 108B at the second end 104B. The inner member 102 further defines a first groove 110A proximate the first end 104A and a second groove 110B proximate the second end 104B. Moreover, the inner member 102 defines a mounting opening 112 disposed between the first groove 110A and the second groove 110B. The mounting opening 112 may define a central axis A-A′.

The system 100 also includes a first bracket member 114A and a second bracket member 114B. The first bracket member 114A includes a first retaining portion 116A disposed adjacent to the first end 104A of the inner member 102. The first bracket member 114A also includes a pair of first projecting portion 118A extending from ends of the first bracket member 114A. Each of the pair of first projecting portions 118A is disposed adjacent to a corresponding lateral end 106 of the inner member 102. Similarly, the second bracket member 114B includes a second retaining portion 116B disposed adjacent to the second end 104B of the inner member 102. The second bracket member 114B also includes a pair of second projecting portion 118B extending from ends of the second bracket member 114B of the second retaining portions 116B. Each of the pair of second projecting portions 118B is disposed adjacent to a corresponding lateral end 106 of the inner member 102. Each of the first and second projecting portions 118A, 118B defines holes 119A, 119B, respectively. Each set of the holes 119A, 119B is adapted to receive a fastening member 120. The fastening member 120 is arranged to detachably couple each of first and second projecting portions 118A, 118B to one another. In the present embodiment the fastening member 120 is a threaded bolt and nut. However, in various alternate embodiments, the fastening member 120 may be a hook, a clasp, and the like.

The system 100 also includes a plurality of first spacer members 122A and a plurality of second spacer members 122B. The first spacer members 122A are disposed between the first retaining portion 116A of the first bracket member 114A and the first end 104A of the inner member 102. Further, each of the plurality of first spacer members 122A and a corresponding first recess 108A of the plurality of first recesses 108A of the inner member 102 are structured and arranged to detachably retain a corresponding hose 101 of the plurality of hoses 101 therebetween. Similarly, the second spacer members 122B are disposed between the second retaining portion 116B of the second bracket member 114B and the second end 104B of the inner member 102. Further, each of the plurality of second spacer members 122B and a corresponding second recess 108B of the plurality of second recesses 108B of the inner member 102 are structured and arranged to detachably retain a corresponding hose 101 of the plurality of hoses 101 therebetween. In an embodiment, each of the first and second spacer members 122A, 122B may be made of an elastomeric material, such as rubber. In the illustrated embodiment, sizes of the first and second spacer members 122A, 122B are different for accommodating hoses with different diameters.

The system 100 also includes a first pusher member 202A and a second pusher member 202B. The first pusher member 202A includes a first inner surface 204A facing the first end 104A of the inner member 102 and a first outer surface 206A opposite to the first inner surface 204A. The first pusher member 202A includes a first cover member 208A disposed on the first outer surface 206A. The first cover member 208A is adapted to selectively press against the plurality of hoses 101 retained at the first end 104A of the inner member 102. Similarly, the second pusher member 202B includes a second inner surface 204B facing the second end 104B of the inner member 102 and a second outer surface 206B opposite to the second inner surface 204B. The second pusher member 202B also includes a second cover member 208B disposed on the second outer surface 206B. The second cover member 208B is adapted to selectively press against the plurality of hoses 101 retained at the second end 104B of the inner member 102. In an embodiment, at least one of the first and second cover members 208A, 208B may be an adhesive tape or made of materials, such as rubber, plastic, and the like.

The system 100 also includes a first locking member 210A and a second locking member 210B. The first locking member 210A includes a first base portion 212A which is slidably received in the first groove 110A of the inner member 102. The first base portion 212A further includes a plurality of first protruding portions 214A. The first protruding portions 214A extend from the first base portion 212A along a second direction “Q” and are adapted to contact the first inner surface 204A of the first pusher member 202A.

Similarly, the second locking member 210B includes a second base portion 212B which is slidably received in the second groove 110B of the inner member 102. The second base portion 212B further includes a plurality of second protruding portions 214B. The second protruding portions 214B extend from the second base portion 212B along a first direction “P” opposite to the second direction “Q”. Further, the second protruding portions 214B are adapted to contact the second inner surface 204B of the second pusher member 202B.

The first base portion 212A and the second base portion 212B also include ends 216A and 216B, respectively. The respective ends 216A, 216B of the first base portion 212A and the second base portion 212B are coupled by a pair of spring members 217. Each of the pair of spring members 217 is adapted arranged to bias the first base portion 212A along the first direction “P” and the second base portion 212B along the second direction “Q”.

The first locking member 210A further includes a first rack portion 218A extending from the first base portion 212A along the first direction “P”. Similarly, the second locking member 210B includes a second rack portion 218B extending from the second base portion 212B along the second direction “Q”. In the illustrated embodiment, each of the first and second rack portions 218A, 218B includes multiple teeth.

The system 100 includes a gear member 302. The gear member 302 includes a mounting portion 306 rotatably received in the mounting opening 112 of the inner member 102. The gear member 302 is rotatable about the central axis A-A′. The gear member 302 also includes a gear portion 304 disposed adjacent to the mounting portion 306. The mounting portion 306 may be a splined shaft received within a splined central opening (not shown) of the gear portion 304. Further, the first rack portion 218A and second rack portion 218B are adapted to engage with the gear portion 304 of the gear member 302. Rotation of the gear member 302 about the central axis A-A′ results in linear movements of the first and second rack portions 218A, 218B, and thus the first and second base portions 212A, 212B in opposite directions. Further, the first and second protruding portions 214A, 214B also move in opposite directions similar to the first and second base portions 212A, 212B. The directions of the linear movements depend on a direction of rotation of the gear member 302. Further, walls of the first and second grooves 110, 110B provide inner and outer limits to the linear movements of the first and second base portions 212A, 212B, respectively, relative to the central axis A-A′.

The system 100 further includes an outer member 310 disposed on the inner member 102. The outer member 310 further includes a middle portion 312, a first lateral portion 314A and a second lateral portion 314B. The first lateral portion 314A is disposed adjacent to the middle portion 312 proximal to the first end 104A of the inner member 102. Further, the first lateral portion 314A defines a plurality of first apertures 316A. The plurality of first apertures 316A is adapted to movably receive the plurality of first protruding portions 214A of the first locking member 210A therethrough. Each of the first protruding portions 214A projects out from the corresponding the first aperture 316A. Similarly, the second lateral portion 314B is disposed adjacent to the middle portion 312 proximal to the second end 104B of the inner member 102. Further the second lateral portion 314B defines a plurality of second apertures (not shown). The second apertures are arranged to movably receive the second protruding portions 214B of the second locking member 210B therethrough. Each of the second protruding portions 214B projects out from of the corresponding second aperture. The middle portion 312 also defines a central hole 318 that may be co-axially aligned with the mounting opening 112 of the inner member 102 and the gear member 302 along the central axis A-A′.

In the illustrated embodiment, the outer member 310 and the inner member 102 define a space therebetween. The gear member 302, the first and second rack portions 218A, 218B, and the first and second base portions 212A, 212B are encased by the outer member 310 and the inner member 102. Further, the first and second bracket members 114A, 114B includes retaining portions 123A, 123B adjacent to the first and second projecting portions 118A, 118B, respectively. The retaining portions 123A of the first bracket member 114A extend towards one another. Similarly, the retaining portions 123B of the second bracket member 114B extend towards one another. In an assembled state of the system 100, the retaining portions 123A, 123B may be adapted to detachably retain the outer member 310 on the inner member 102. Specifically, the retaining portions 123A, 123B may prevent any relative movement between the inner member 102 and the outer member 310.

The system 100 further includes a ratchet wheel 320. The ratchet wheel 320 is coupled to the gear portion 304 of the gear member 302 to rotatably lock the ratchet wheel 320 with respect to the gear member 302. In an embodiment, the mounting portion 306 may extend through the splined opening of the gear portion 304 and the central hole 318 of the outer member 310 to be received within a splined opening (not shown) of the ratchet wheel 320. Hence, rotation of the ratchet wheel 320 about the central axis A-A′ also results in a similar rotation of the gear member 302. The ratchet wheel 320 further defines a locking recess 322 at a top surface 324 thereof. The locking recess 322 may be co-axially aligned with the central hole 318 of the outer member 310. The locking recess 322 is adapted to engage with a tool (not shown) for rotation of the gear member 302 about the central axis A-A′. In the illustrated embodiment, the locking recess 322 has a hexagonal shape to engage with a spanner or a socket.

The system 100 further includes a block member 326 coupled to the middle portion 312 of the outer member 310. In an embodiment, the block member 326 may be welded to the outer member 310. The block member 326 further defines a hole 328 and a slot 330. The hole 328 is aligned with the locking recess 322 of the ratchet wheel 320. Further, the hole 328 of the block member 326 is adapted to receive a tool therethrough for engagement with the locking recess 322 of the ratchet wheel 320.

The system 100 also includes a pawl member 332 rotatably disposed with respect to the block member 326. The pawl member 332 includes a pawl portion 334 and a lever 336 disposed on the pawl portion 334. The pawl portion 334 is adapted to selectively engage with the ratchet wheel 320 to rotatably lock the gear member 302 about an unlocking direction “D1” about the central axis A-A′. The pawl portion 334 further allows the rotation of the gear member 302 in a locking direction “D2” about the central axis A-A′. Further, the lever 336 extends through the slot 330 of the block member 326. The system 100 further includes a pawl spring 338. The pawl spring 338 is adapted to bias the pawl member 332 into engagement with the ratchet wheel 320.

In the illustrated embodiment, the block member 326 is hollow and encases the ratchet wheel 320, the pawl member 332 and the pawl spring 338. Further, the pawl spring 338 may be coupled to a fixture (not shown) welded to the block member 326 or the outer member 310. Further, the pawl member 332 may be rotatably received in a projection (not shown) of the block member 326 or the outer member 310.

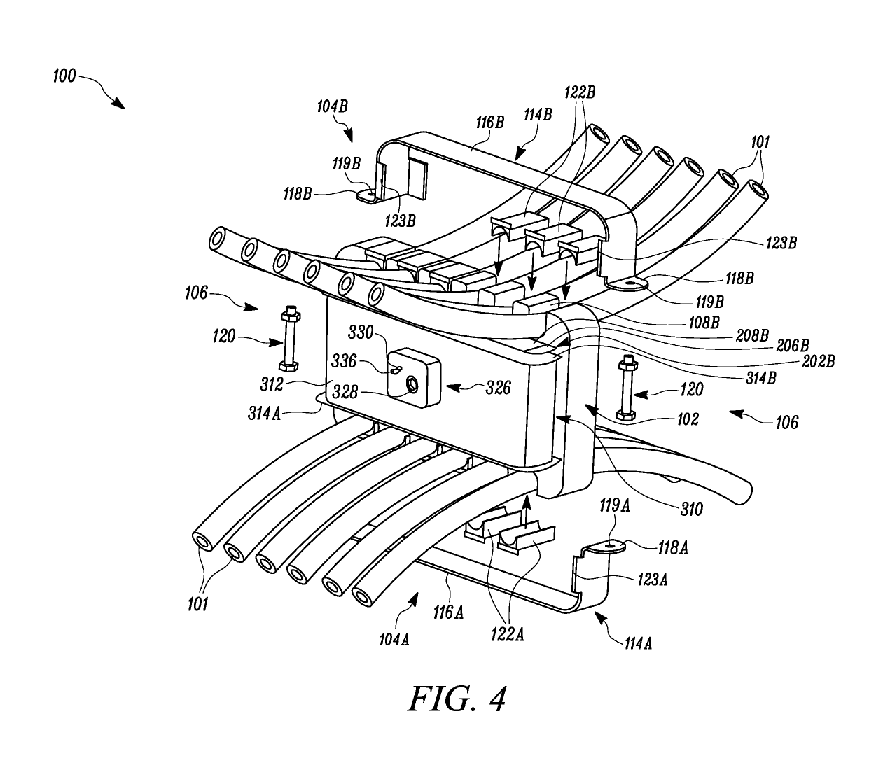

Referring to FIG. 4, an exemplary assembling process of the system 100 is described. The first and second outer brackets 114A, 114B are shown as detached from each other. Each of the hoses 101 at the first end 104A of the inner member 102 is received within the corresponding first recess 108A and the first spacer member 122A. Similarly, each of the hoses 101 at the second end 104B of the inner member 102 is received within the corresponding second recess 108B and the second pacer member 122B. The first and second outer brackets 114A, 114B are then disposed on the first and second spacer members 122A, 122B, respectively. The first and second brackets 114A, 114B are then coupled to each other via the fastening members 120. FIG. 1 shows the hoses 101 are retained by the system 100.

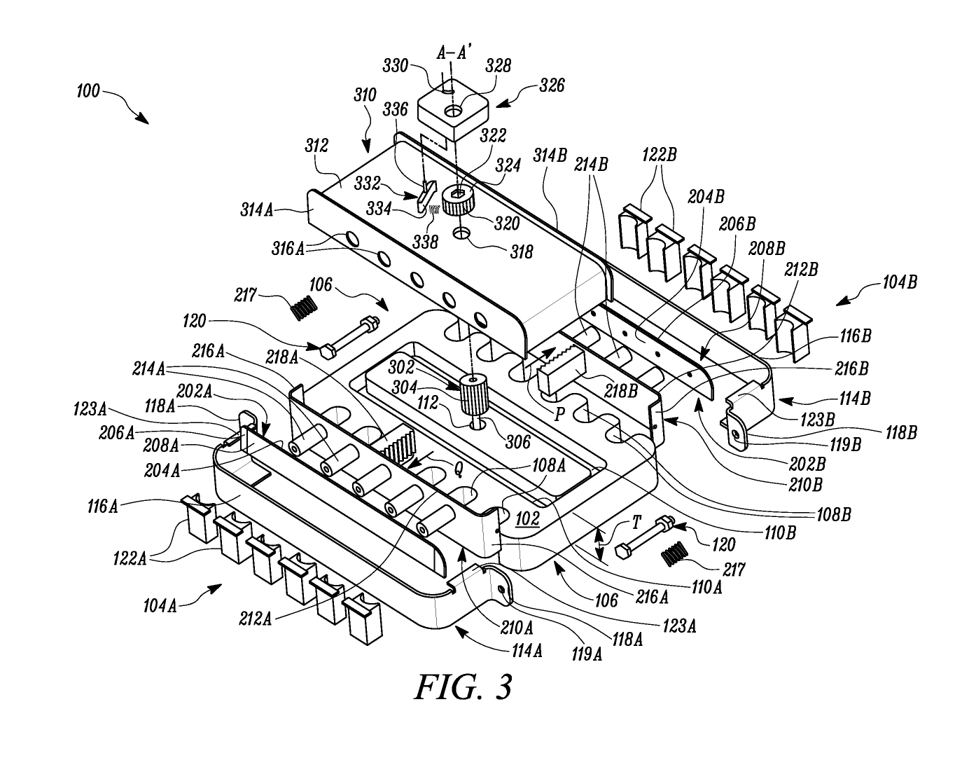

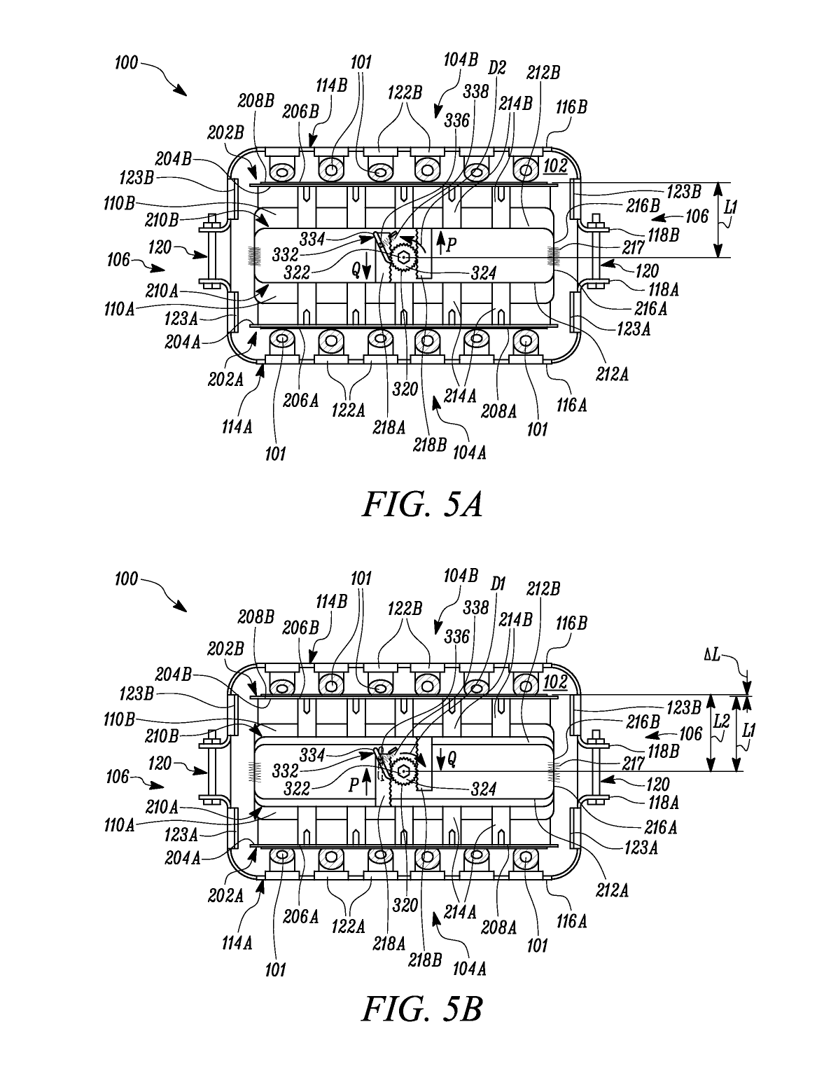

Referring to FIGS. 5A and 5B, the gear member 302 is configured to be rotated in the locking direction “D2” to move the first locking member 210A along the second direction “Q” and the second locking member 210B along the first direction “P” to move the first pusher member 202A and the second pusher 202B into pressing engagement the hoses 101. Further, the first and second cover members 208A, 208B contact the hoses 101. As shown in FIG. 5A, in an uncoupled configuration of the system 100, a distance between the first pusher member 202A and the central axis A-A′ is “L1”. Due to rotation of the gear portion 304 in the locking direction D2, the first and second pusher members 202A, 202B move towards the hoses 101. As shown in FIG. 5B, in a coupled configuration of the system 100, a distance between the first pusher member 202A and the central axis A-A′ “L1” is increased to “L2”. A distance “ΔL” is a difference between the distances “L1” and “L2”. The first and second pushers 202A, 202B are configured to be moved by a distance “ΔL” due to the rotation of the gear member 302. The distance “ΔL” may be determined by widths of the first and second grooves 110A, 110B (shown in FIG. 3) of the inner member 102. Further, the lever 336 is configured to be moved in the slot 330 of the block member 326 to disengage the pawl portion 334 of the pawl member 332 from the ratchet wheel 320 and allow the gear member 332 to rotate in the unlocking direction “D1” in order to remove the first pusher member 202A and the second pusher member 202B from pressing engagement with the plurality of hoses 101. The biasing of the spring member 217 enable rotation of the gear member 332 in the unlocking direction D1 once the pawl portion 334 is disengaged (shown by dotted line in FIG. 5B) from the ratchet wheel 320 due to movement of the lever 336 in the slot 330.

After assembly of the hoses 101 with the system 100, the gear member 302 may be rotated in the locking direction “D2” in order to move the first and second pusher members 202A, 202B into pressing engagement with the hoses 101. A tool may be inserted through the hole 328 (shown in FIG. 3) and engaged with the locking recess 322. As illustrated in FIG. 4B, the hoses 101 are deformed by the first and second pusher members 202A, 202B against a pressure of hydraulic fluid flowing therethrough. Further, on disengagement of the pawl portion 334 from the ratchet wheel 320 due to movement of the lever 336, the gear member 302 rotates in the unlocking direction “D1”, thereby moving the first and second pusher members 202A, 202B away from the hoses 101. One or more of the hoses 101 may be removed or replaced from the system 100 by uncoupling the first and second brackets 114A, 114B, and then removing the corresponding first and/or second spacer members 122A, 122B. In the illustrated embodiment, the unlocking direction “D1” is clockwise while the locking direction “D2” is counter clockwise. However, in an alternative embodiment, the unlocking and locking directions “D1”, “D2” may be reversed base on a configuration of the system 100.

### INDUSTRIAL APPLICABILITY

The present disclosure relates to the system 100 for detachably retaining the plurality of hoses 101. The system 100 may be freely supported on the hoses 101, or may be fastened or welded at any suitable location on the machine. Further, the first and second spacer members 122A, 122B may be of different dimensions to retain hoses with different diameters. It may be contemplated that one or more of the systems 100 may be disposed at various locations along the lengths of the hoses 101 to minimize sagging and maintain a desired routing profile of the hoses.

The system 100 also maintains the hoses 101 at a distance from each other. This prevents rubbing between the hoses 101, thereby reducing wear. Further, materials of the inner member 102 and the first and second spacer members 122A, 122B may be suitably chosen to reduce wear of the hoses 101. Moreover, the first and second cover members 208A, 208B may prevent contact of the first and second outer surfaces 206A, 206B with the hoses 101. This may prevent direct contact of a metallic surface with the hoses 101 and further reduces wear.

Further, the hoses 101 may be quickly and conveniently attached to the system 100 by receiving the hoses 101 between the corresponding first and second recesses 108A, 108B, and the first and second spacer members 122A, 122B, and then coupling the first and second bracket members 114A, 114B to each other. Specifically, the system 100 may be coupled to the hoses 101 without requiring the hoses 101 to be routed through the inner member 102. Therefore, in case the hoses 101 are already assembled with hydraulic components at the both ends, the system 100 may be installed without detaching the hoses 101 from the hydraulic components.

Further, the pressing engagement of the first and second pusher members 202A, 202B with the hoses 101 may also prevent any undesired movement of the hoses 101. Further, the hole 328 and the locking recess 322 may enable a simple tool, such as a wrench or a socket, to move the first and second pusher members 202A, 202B into pressing engagement with the hoses. The engagement between the pawl portion 334 and the ratchet wheel 320 may also prevent loosening of the hoses 101 once the tool is removed. The lever 336 extends through the slot 330 of the block member 326, thereby allowing convenient actuation of the lever 336 to release the first and second pusher members 202A, 202B from pressing engagement with the hoses 101. Moreover, the biasing of the springs 217 move of the first and second pusher members 202A, 202B away from the hoses 101 after the pawl portion 334 is disengaged from the ratchet wheel 320. This may also allow safe release of the hoses 101 from a deformed state. Further, one or more of the hoses 101 may be removed or replaced.

The outer member 310 and the block member 326 also encases various components of the system 100, such as the gear member 302, the ratchet wheel 320 and the pawl member 332. This may protect the components against environmental elements, such as dust, moisture, and the like.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A system for detachably retaining a plurality of hoses, the system comprising:
an inner member having a first end, a second end distal to the first end and a pair of lateral ends extending between the first end and the second end, the inner member defining a plurality of first recesses at the first end and a plurality of second recesses at the second end, the inner member further defining a first groove proximate the first end, a second end groove proximate the second end and a mounting opening disposed between the first groove and the second groove;
a first bracket member comprising a first retaining portion disposed adjacent to the first end of the inner member and a pair of first projecting portions extending from ends of the first retaining portion, wherein each of the pair of projecting portions is disposed adjacent to a corresponding lateral end of the pair of lateral ends of the inner member;
a second bracket member comprising a second retaining portion disposed adjacent to the second end of the inner member and a pair of second projecting portions extending from ends of the first retaining portion, wherein each of the pair of second projecting portions is disposed adjacent to a corresponding lateral end of the pair of lateral ends of the inner member;
a fastening member arranged to detachably couple each of the pair of first projecting portions of the first bracket member to each of the pair of second projecting portions of the second bracket member;
a plurality of first spacer members disposed between the first retaining portion of the first bracket member and the first end of the inner member, wherein each of the plurality of first spacer members and a corresponding first recess of the plurality of first recesses of the inner member are structured and arranged to detachably retain a corresponding hose of the plurality of hoses therebetween;
a plurality of second spacer members disposed between the second retaining portion of the second bracket member and the second end of the inner member, wherein each of the plurality of second spacer members and a corresponding second recess of the plurality of second recesses of the inner member are structured and arranged to detachably retain a corresponding hose of the plurality of hoses therebetween;
a gear member comprising a mounting portion rotatably received in the mounting opening of the inner member, a first gear portion disposed adjacent to the mounting portion and a ratchet wheel disposed adjacent to the first gear portion, wherein the ratchet wheel defines a locking recess at a top surface thereof;
a first locking member comprising a first base portion slidably received in the first groove of the inner member, a first rack portion extending from the first base portion along a first direction and arranged to engage with the first gear portion of the gear member, and a plurality of first protruding portions extending from the first base portion along a second direction opposite to the first direction;
a second locking member comprising a second base portion slidably received in the second groove of the inner member, a second rack portion extending from the second base portion along the second direction and arranged to engage with the first gear portion of the gear member, and a plurality of second protruding portions extending the second base portion along the first direction;
a pair of spring members coupled between respective ends of the first base portion of the first locking member and respective ends of the second base portion of the second locking member, wherein each of the pair of spring members is arranged to bias the first base portion along the first direction and the second base portion along the second direction;
a first pusher member having an inner surface arranged to contact the plurality of first protruding portions of the first locking member and an outer surface opposite to the inner surface, the first pusher comprising a first cover member disposed on the outer surface thereof, wherein the first cover member is arranged to selectively press against the plurality of hoses retained at the first end of the inner member;
a second pusher member having an inner surface arranged to contact the plurality of second protruding portions of the second locking member and an outer surface opposite to the inner surface, the second pusher member comprising a second cover member disposed on the outer surface thereof, wherein the second cover member is arranged to selectively press against the plurality of hoses retained at the second end of the inner member;
an outer member disposed on the inner member, the outer member comprising a middle portion defining a central aperture aligned with the locking recess of the ratchet wheel of the gear member, a first lateral portion disposed adjacent to the middle portion and defining a plurality of first apertures arranged to movably receive the plurality of first protruding portions of the first locking member therethrough, and a second lateral portion disposed adjacent to the middle portion and defining a plurality of second apertures arranged to movably receive the plurality of second protruding portions of the second locking member therethrough;
a block member coupled to the middle portion of the outer member, the block member defining a hole aligned with the central aperture of the middle portion and a slot, wherein the hole of the block member, the central aperture of the middle portion and the locking recess of the ratchet wheel are configured to receive a tool for rotation of the gear member;
a pawl member rotatably disposed with respect to the outer member, the pawl member comprising a pawl portion configured to selectively engage with the ratchet wheel of the gear member to rotatably lock the gear member about a unlocking direction and allow rotation of the gear member about a locking direction, the pawl member further comprising a lever disposed on the pawl portion and extending through the slot of the block member; and
a pawl spring configured to bias the pawl member into engagement with the ratchet wheel of the gear member;
wherein the gear member is configured to be rotated about the locking direction to move the first locking member along the second direction and the second locking member along the first direction in order to move the first pusher member and the second pusher into pressing engagement with the plurality of hoses; and
wherein the lever is configured to be moved in the slot of the block member to disengage the pawl portion of the pawl member from the ratchet wheel of the gear member and allow the gear member to rotate about the unlocking direction in order to remove the first pusher member and the second pusher member from pressing engagement with the plurality of hoses.
